(19) United States
(12) Patent Application Publication
(10) Pub. No.: US 2025/0029995 A1
(43) Pub. Date: Jan. 23, 2025

(54) POSITIVE ELECTRODE AND SECONDARY BATTERY USING THE SAME

(71) Applicant: Prime Planet Energy & Solutions, Inc., Tokyo (JP)

(72) Inventor: Yuji YAMAMOTO, Toyota-shi (JP)

(21) Appl. No.: 18/767,985

(22) Filed: Jul. 10, 2024

(30) Foreign Application Priority Data
Jul. 20, 2023 (JP) 2023-117972

(51) Int. Cl. H01M 4/525; H01M 4/02; H01M 4/04; H01M 10/0525

(52) U.S. Cl. CPC H01M 4/525; H01M 4/0404; H01M 10/0525; H01M 2004/021; H01M 2004/028

(57) ABSTRACT

A positive electrode disclosed here includes: a positive electrode current collector; and a positive electrode active material layer supported by the positive electrode current collector. The positive electrode active material layer includes a first lithium composite oxide having a layered structure and a second lithium composite oxide having a layered structure. In the first lithium composite oxide, a mole ratio of Li to a metal other than Li is 0.90 to 0.97. In the second lithium composite oxide, a mole ratio of Li to a metal other than Li is 1.10 to 1.20. A crystallite size of a (104) plane of the first lithium composite oxide is 400 Å to 600 Å. A crystallite size of a (104) plane of the second lithium composite oxide is larger than the crystallite size of the (104) plane of the first lithium composite oxide.

### TECHNICAL FIELD

The present disclosure relates to a positive electrode. The present disclosure also relates to a secondary battery using the positive electrode. This application claims the benefit of priority to Japanese Patent Application No. 2023-117972 filed on Jul. 20, 2023. The entire contents of this application are hereby incorporated herein by reference.

### BACKGROUND

Recent secondary batteries such as lithium ion secondary batteries are suitably used for, for example, portable power supplies for devices such as personal computers and portable terminals, and power supplies for driving vehicles such as battery electric vehicles (BEVs), hybrid electric vehicles (HEVs), and plug-in hybrid electric vehicles (PHEVs).

A positive electrode used for a secondary battery such as a lithium ion secondary battery typically employs a positive electrode active material. As the positive electrode active material, a lithium composite oxide is often used. Patent Document 1 discloses that a lithium composite oxide having a Li/Me ratio of one or less and a Li-excessive lithium composite oxide (i.e., lithium composite oxide having a Li/Me ratio exceeding one) are combined as a positive electrode active material and a crystallite size of the lithium composite oxide having a Li/Me ratio of one or less is set at 180 nm or more (1800 Å or more), so that characteristics such as an output characteristic and a capacity characteristic of the secondary battery can be enhanced. It should be noted that the Li/Me ratio of a lithium composite oxide is a mole ratio of Li to a metal (Me) other than Li.

### CITATION LIST

### Patent Document

Patent Document 1: Japanese Translation of PCT International Application No. 2021-518049

### SUMMARY

A result of intensive studies of the inventor of the present disclosure, however, it has been found out that a new problem that the conventional technique described above cannot achieve both a capacity characteristic and an output characteristic at high level.

Embodiments of the present disclosure provide positive electrodes each capable of providing a secondary battery with both a capacity characteristic and an output characteristic at high level.

A positive electrode includes: a positive electrode current collector; and a positive electrode active material layer supported by the positive electrode current collector. The positive electrode active material layer includes a first lithium composite oxide having a layered structure and a second lithium composite oxide having a layered structure. In the first lithium composite oxide, a mole ratio of Li to a metal other than Li is 0.90 to 0.97. In the second lithium composite oxide, a mole ratio of Li to a metal other than Li is 1.10 to 1.20. A crystallite size of a (104) plane of the first lithium composite oxide is 400 Å to 600 Å. A crystallite size of a (104) plane of the second lithium composite oxide is larger than the crystallite size of the (104) plane of the first lithium composite oxide.

This configuration can provide a positive electrode capable of providing a secondary battery with both a capacity characteristic and an output characteristic at high level.

In another aspect, a secondary battery disclosed here includes the positive electrode described above, a negative electrode, and an electrolyte. This configuration can provide a secondary battery showing both a capacity characteristic and an output characteristic at high level.

### BRIEF DESCRIPTION OF THE DRAWINGS

FIG. 1 is a cross-sectional view schematically illustrating a positive electrode according to one embodiment of the present disclosure.

FIG. 2 is a cross-sectional view schematically illustrating an internal structure of a lithium ion secondary battery according to one embodiment of the present disclosure.

FIG. 3 is a schematic disassembled view illustrating a structure of a wound electrode body of a lithium ion secondary battery according to one embodiment of the present disclosure.

### DETAILED DESCRIPTION

An embodiment of the present disclosure will be described hereinafter with reference to the drawings. Matters not specifically mentioned herein but required for carrying out the present disclosure can be understood as matters of design of a person skilled in the art based on related art in the field. The present disclosure can be carried out on the basis of the contents disclosed in the description and common general knowledge in the field. In the drawings, members and parts having the same functions are denoted by the same reference characters for description. Dimensional relationships (e.g., length, width, and thickness) in the drawings do not reflect actual dimensional relationships. A numerical range expressed as “A to B” herein includes A and B.

It should be noted that a “secondary battery” herein refers to a power storage device capable of being repeatedly charged and discharged. A “lithium ion secondary battery” herein refers to a secondary battery that uses lithium ions as charge carriers and performs charge and discharge by movement of charges accompanying lithium ions between positive and negative electrodes.

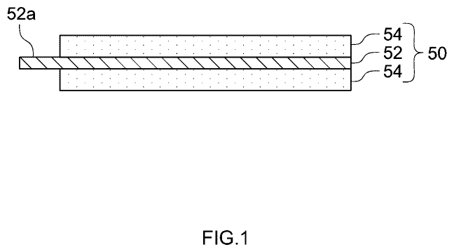

The present disclosure will be described in detail hereinafter using a positive electrode for use in a lithium ion secondary battery as an example, but the present disclosure is not intended to be limited to these embodiments. FIG. 1 is a schematic cross-sectional view of a positive electrode according to this embodiment taken along a thickness direction and a width direction.

As illustrated in FIG. 1, a positive electrode 50 includes a positive electrode current collector 52, and a positive electrode active material layer 54 supported by the positive electrode current collector 52. In the illustrated example, the positive electrode active material layer 54 is provided on each surface (i.e., both surfaces) of the positive electrode current collector 52. Alternatively, the positive electrode active material layer 54 may be provided on one surface of the positive electrode current collector 52. Desirably, the positive electrode active material layer 54 is provided on each surface of the positive electrode current collector 52.

As shown in the illustrated example, a positive electrode active material layer non-formed portion 52a including no positive electrode active material layer 54 may be provided at one end of the positive electrode 50 in the width direction. In the positive electrode active material layer non-formed portion 52a, the positive electrode current collector 52 is exposed so that the positive electrode active material layer non-formed portion 52 can function as a current collecting portion. However, the structure for collecting electricity from the positive electrode 50 is not limited to this example.

The positive electrode current collector 52 may be a known positive electrode current collector for use in a lithium ion secondary battery, and examples of the positive electrode current collector 52 include sheets or foil of highly conductive metals (e.g., aluminium, nickel, titanium, and stainless steel). The positive electrode current collector 52 is desirably aluminum foil.

Dimensions of the positive electrode current collector 52 are not particularly limited, and may be appropriately determined depending on battery design. In the case of using aluminum foil as the positive electrode current collector 52, the thickness thereof is not particularly limited, and is, for example, 5 μm or more and 35 μm or less, desirably 7 μm or more and 20 μm or less.

The positive electrode active material layer 54 contains a positive electrode active material. In this embodiment, as a positive electrode active material, a first lithium composite oxide having a layered structure and a second lithium composite oxide having a layered structure are used in combination. Thus, the positive electrode active material layer contains at least the first lithium composite oxide and the second lithium composite oxide. In the following description, when the term “lithium composite oxide” is simply used, features described with this term are applicable to both the first lithium composite oxide and the second lithium composite oxide.

Examples of the type of the lithium composite oxide having a layered structure include a lithium nickel composite oxide, a lithium cobalt composite oxide, a lithium manganese composite oxide, a lithium nickel cobalt manganese composite oxide, a lithium nickel cobalt aluminium composite oxide, and a lithium iron nickel manganese composite oxide.

It should be noted that the “lithium nickel cobalt manganese composite oxide” herein includes not only oxides including Li, Ni, Co, Mn, and O as constituent elements, but also an oxide further including one or more additive elements besides them. Examples of the additive elements include transition metal elements and typical metal elements such as Mg, Ca, Al, Ti, V, Cr, Y, Zr, Nb, Mo, Hf, Ta, W, Na, Fe, Zn, and Sn. The additive element may be a metalloid element such as B, C, Si, or P, and a nonmetal element such as S, F, Cl, Br, or I. This also applies, in the same manner, to the lithium nickel composite oxide, the lithium cobalt composite oxide, the lithium manganese composite oxide, the lithium nickel cobalt aluminium composite oxide, and the lithium iron nickel manganese composite oxide described above.

The first lithium composite oxide and the second lithium composite oxide may be of the same type or different types.

In the case of using different types of lithium composite oxides, the first lithium composite oxide and the second lithium composite oxide can be easily distinguished from each other.

In the case of using the same type of lithium composite oxide, characteristics of the lithium ion secondary battery 100 can be easily adjusted. In the case of using the same type of the lithium composite oxide, both the first lithium composite oxide and the second lithium composite oxide are desirably a lithium nickel cobalt manganese composite oxide or a lithium nickel cobalt aluminum composite oxide, more desirably a lithium nickel cobalt manganese composite oxide. It should be noted that the term “the same type” regarding lithium composite oxides herein refers to cases where the lithium composite oxides contain identical constituent elements. Therefore, if both the first lithium composite oxide and the second lithium composite oxide are lithium nickel cobalt manganese composite oxides, even through the ratios of the constituent elements differ between these oxides, these oxides are considered to be of the same type of the lithium composite oxide.

The positive electrode active material may consist only of the first lithium composite oxide and the second lithium composite oxide. Alternatively, the positive electrode active material layer 54 may include a positive electrode active material other than the first lithium composite oxide and the second lithium composite oxide within a range that does not significantly inhibit the effects of the present disclosure (e.g., 10% by mass or less, 5% by mass or less, or 1% by mass or less of the positive electrode active material).

In the first lithium composite oxide, a mole ratio of Li to a metal (Me) other than Li (hereinafter referred to as a “Li/Me ratio”) is 0.90 to 0.97. On the other hand, in the second lithium composite oxide, a mole ratio of Li to a metal (Me) other than Li (Li/Me ratio) is 1.10 to 1.20.

In addition, the crystallite size of a (104) plane of the first lithium composite oxide is 400 Å to 600 Å. The crystallite size of a (104) plane of the second lithium composite oxide is larger than the crystallite size of the (104) plane of the first lithium composite oxide.

As described above, when the Li/Me ratios of the two types of the lithium composite oxides are within the ranges described above and the crystallite sizes of the (104) planes are within the ranges described above, an output characteristic and a capacity characteristic of the lithium ion secondary battery 100 using the positive electrode 50 can be improved. This is supposed to be because of the following reasons. By allowing the Li/Me ratios to be balanced and limiting the crystallite sizes, in lithiation of a lithium composite oxide (especially the first lithium composite oxide), formation of an unnecessary resistance layer (Li₂CO₃ or LiOH) on the surface of the lithium composite oxide is suppressed, and a crystal structure is rearranged. These contribute to enhancement of an output characteristic and a capacity characteristic.

Specifically, when the Li/Me ratio of the first lithium composite oxide is out of the range from 0.90 to 0.97, the capacity characteristic is insufficient. When the Li/Me ratio of the second lithium composite oxide is out of the range from 1.10 to 1.20, the capacity characteristic is also insufficient. From the viewpoint of an increase in capacity of the lithium ion secondary battery 100, the Li/Me ratio of the second lithium composite oxide is desirably 1.10 to 1.15, more desirably 1.10 to 1.12.

When the crystallite size of the (104) plane of the first lithium composite oxide is out of the range from 400 Å to 600 Å, the output characteristic is insufficient. The crystallite size of the (104) plane of the first lithium composite oxide is desirably 500 Å to 600 Å, more desirably 550 Å to 600 Å, even more desirably 580 Å to 600 Å.

When the crystallite size of the (104) plane of the second lithium composite oxide is less than or equal to the crystallite size of the (104) plane of the first lithium composite oxide, the output characteristic is insufficient. The crystallite size of the (104) plane of the second lithium composite oxide is desirably larger than the crystallite size of the (104) plane of the first lithium composite oxide by 50 Å or more, more desirably by 100 Å or more, even more desirably by 150 Å or more, particularly desirably by 200 Å or more. The crystallite size of the (104) plane of the second lithium composite oxide is desirably 500 Å to 900 Å, more desirably 600 Å to 800 Å.

The Li/Me ratio and the crystallite size of the lithium composite oxide can be adjusted according to a known method. For example, a lithium composite oxide is generally produced by mixing a precursor containing a metal element (Me) other than Li (e.g., hydroxide containing Me, a carbonate containing Me, etc.), a Li-source compound (e.g., lithium hydroxide, lithium carbonate, lithium chloride, etc.), and firing the mixture. The Li/Me ratio here can be controlled by adjusting a mixing ratio of the precursor and the Li-source compound. The crystallite size can be controlled by adjusting firing conditions. In particular, the crystallite size tends to increase as the firing temperature increases.

In a used lithium ion secondary battery, desorption of Li might reduce the Li/Me ratio of a lithium composite oxide. In addition, expansion/contraction of the lithium composite oxide in charge/discharge cycles might damage crystallite and reduce the size of crystallites. Thus, in the used lithium ion secondary battery, a lithium composite oxide with a layered structure in which the Li/Me ratio is in the range from 0.90 to 0.97, and the crystallite size of the (104) plane is in the range from 400 Å to 600 Å might be generated.

In view of this, in this embodiment, a lithium composite oxide with a layered structure collected from a used lithium ion secondary battery can be used as the first lithium composite oxide. This is advantageous from the viewpoint of environmental load reduction. This lithium composite oxide can be collected from the used lithium ion secondary battery according to a known method. For example, a used lithium ion secondary battery is disassembled, a positive electrode is taken out from the battery, a positive electrode active material layer is peeled off from a positive electrode current collector, a binder is removed with a solvent, and then a lithium composite oxide and a conductive material are separated by a classification technique or other techniques, thereby obtaining a lithium composite oxide. On the other hand, the second lithium composite oxide may be a non-recycled lithium composite oxide.

It should be noted that the crystallite size of the (104) plane of the lithium composite oxide can be determined by performing X-ray diffraction (XRD) measurement on lithium composite oxide powder. Specifically, an X-ray diffraction pattern is measured with a known X-ray diffraction (XRD) apparatus to calculate a crystallite size using a full width at half maximum (FWHM) of a diffraction peak (2θ=44±1°) belonging to a (004) plane, a 2θ value, and a Scherrer equation. It should be noted that in a case where the positive electrode active material is already included in the positive electrode, only the positive electrode active material may be isolated according to a known method and used as a measurement sample.

In a case where the first lithium composite oxide is a lithium nickel cobalt manganese composite oxide, the first lithium composite oxide has a composition expressed by, for example, Formula (I):

Liₓ₁Ni_{y1}CO_{z1}Mn_{(1-y1-z1)}M1_{α1}O_{2-β1}Q1_{β1} (I)

In Formula (I), x1, y1, z1, α1, and β1 respectively satisfy 0.90≤x1≤0.97, 0<y1≤0.40, 0<z1≤0.40, 0≤α1≤0.10, and 0≤β1≤0.5. M1 is at least one element selected from the group consisting of Zr, Mo, W, Mg, Ca, Na, Fe, Cr, Zn, Sn, B, and Al. Q1 is at least one element selected from the group consisting of F, Cl, and Br.

y1 desirably satisfies 0.05≤y1≤0.40. z1 desirably satisfies 0.05≤z1≤0.40. α1 desirably satisfies 0≤α1≤0.05, more desirably satisfies 0≤α1≤0.03. β1 desirably satisfies 0≤β1≤0.1, is more desirably 0.

In a case where the second lithium composite oxide is a lithium nickel cobalt manganese composite oxide, the second lithium composite oxide has a composition expressed by, for example, Formula (II):

Liₓ₂Ni_{y2}CO_{z2}Mn_{(1-y2-z2)}M2_{α2}O_{2-β2}Q2_{β2} (II)

In Formula (II), x2, y2, z2, α2, and β2 respectively satisfy 1.10≤x≤1.20, 0<y2≤0.40, 0<z2≤0.40, 0≤α2≤0.10, and 0≤β2<0.5. M2 is at least one element selected from the group consisting of Zr, Mo, W, Mg, Ca, Na, Fe, Cr, Zn, Sn, B, and Al. Q2 is at least one element selected from the group consisting of F, Cl, and Br.

x2 desirably satisfies 1.10≤x2≤1.15, more desirably satisfies 1.10≤x2≤1.12. y2 desirably satisfies 0.05≤y2≤0.40. z2 desirably satisfies 0.05≤z2≤0.40. α2 desirably satisfies 0≤α2≤0.05, more desirably satisfies 0≤α2≤0.03. β2 desirably satisfies 0≤β2≤0.1, is more desirably 0.

The compositions of the first lithium composite oxide and the second lithium composite oxide, except for the Li/Me ratio may be the same or different.

In the case where the first lithium composite oxide and the second lithium composite oxide have different compositions, the first lithium composite oxide and the second lithium composite oxide can be easily distinguished.

In the case where the first lithium composite oxide and the second lithium composite oxide have the same composition except for the Li/Me ratio, characteristics of the lithium ion secondary battery 100 can be easily adjusted. In this case, in Formula (I) and Formula (II) described above, for example, x1 and x2 are different, but y1=y2, z1=z2, α1=α2, β1=β2, M1=M2, and Q1=Q2.

The average particle size (D50) of each of the first lithium composite oxide and the second lithium composite oxide is not particularly limited, and is, for example, 0.05 μm to 25 μm. The average particle size (D50) of the first lithium composite oxide is desirably 1 μm to 15 μm, more desirably 2 μm to 12 μm, even more desirably 3 μm to 8 μm. In a case where the average particle size (D50) of the first lithium composite oxide is 3 μm to 8 μm, the lithium ion secondary battery have an especially high output characteristic. The average particle size (D50) of the second lithium composite oxide is desirably 1 μm to 15 μm, more desirably 2 μm to 12 μm.

It should be noted that the “average particle size (D50)” herein means a particle size corresponding to a cumulative frequency of 50% by volume from the small-size particle side in volume-based particle size distribution based on a laser diffraction and scattering method. Thus, the average particle size (D50) can be obtained by using, for example, a known particle size distribution analyzer of a laser diffraction and scattering type.

The mixing ratio of the first lithium composite oxide and the second lithium composite oxide is not particularly limited, and the mass ratio of the first lithium composite oxide and the second lithium composite oxide is, for example, 5:95 to 95:5, desirably 10:90 to 90:10, more desirably 30:70 to 70:30, even more desirably 40:60 to 60:40.

The content of the positive electrode active material in the positive electrode active material layer 54 (i.e., content of the positive electrode active material with respect to the total mass of the positive electrode active material layer 54) is not particularly limited, and is desirably 87 mass % or more, more desirably 90 mass % or more, even more desirably 96 mass % or more.

The positive electrode active material layer 54 may include components other than the positive electrode active material, such as trilithium phosphate, a conductive agent, and a binder. Desired examples of the conductive agent include: carbon black such as acetylene black (AB); carbon nanotubes (CNTs); and other carbon materials (e.g., graphite). Examples of the binder include polyvinylidene fluoride (PVdF). In the case of using CNTs as the conductive material, the positive electrode active material layer 54 may contain a disperser of CNTs.

The content of the positive electrode active material in the positive electrode active material layer 54 (i.e., content of the positive electrode active material with respect to the total mass of the positive electrode active material layer 54) is not particularly limited, and is desirably 70 mass % or more, more desirably 80 mass % or more, even more desirably 85 mass % or more and 99 mass % or less. The content of trilithium phosphate in the positive electrode active material layer 54 is not particularly limited, and is desirably 0.1 mass % or more and 15 mass % or less, more desirably 0.2 mass % or more and 10 mass % or less. The content of the conductive material in the positive electrode active material layer 54 is not particularly limited, and is desirably 0.1 mass % or more and 20 mass % or less, more desirably 0.3 mass % or more and 15 mass % or less. The content of the binder in the positive electrode active material layer 54 is not particularly limited, and is desirably 0.4 mass % or more and 15 mass % or less, more desirably 0.5 mass % or more and 10 mass % or less.

The thickness of the positive electrode active material layer 54 at one side is not particularly limited, and is usually 10 μm or more, desirably 20 μm or more. On the other hand, this thickness is usually 300 μm or less, and desirably 200 μm or less.

In the positive electrode active material layer non-formed portion 52a of the positive electrode 50, an insulating protective layer (not shown) including insulating particles (e.g., ceramic particles) may be provided at a location adjacent to the positive electrode active material layer 54. This protective layer can prevent short circuit between the positive electrode active material layer non-formed portion 52a and the negative electrode.

The positive electrode 50 according to this embodiment can be produced by preparing positive electrode slurry containing a positive electrode active material, an optional component (e.g., binder, conductive material, etc.), and a solvent (dispersion medium), applying the slurry onto the positive electrode current collector 52, drying the slurry, and then performing pressing thereon when necessary.

The positive electrode 50 according to this embodiment can provide the secondary battery with both a capacity characteristic and an output characteristic at high level.

In another aspect, a secondary battery according to this embodiment includes a positive electrode, a negative electrode, and an electrolyte, and this positive electrode is the positive electrode according to this embodiment.

The secondary battery according to this embodiment will now be described using a flat square lithium ion secondary battery including a flat wound electrode body and a flat battery case as an example. The secondary battery according to this embodiment, however, is not limited to the following example.

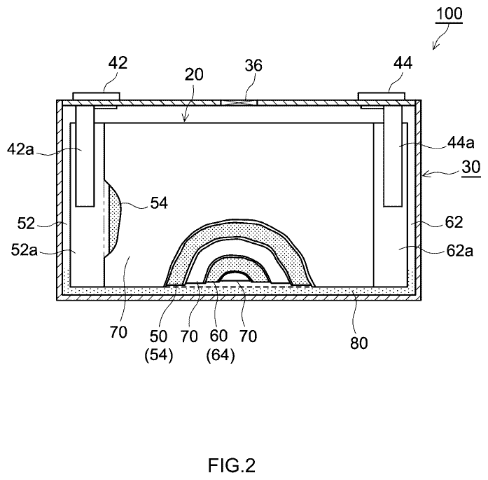

A lithium ion secondary battery 100 illustrated in FIG. 2 is a sealed battery in which a flat wound electrode body 20 and a nonaqueous electrolyte 80 are housed in a flat square battery case (i.e., outer container) 30. The battery case 30 includes a positive electrode terminal 42 and a negative electrode terminal 44 for external connection, and a thin safety valve 36 configured such that when the internal pressure of the battery case 30 increases to a predetermined level or more, the safety valve 36 releases the internal pressure. The battery case 30 has an injection port (not shown) for injecting the nonaqueous electrolyte 80. The positive electrode terminal 42 is electrically connected to a positive electrode current collector plate 42a. The negative electrode terminal 44 is electrically connected to the negative electrode current collector plate 44a. A material for the battery case 30 is, for example, a metal material that is lightweight and has high thermal conductivity, such as aluminum. It should be noted that FIG. 2 does not strictly illustrate the amount of the nonaqueous electrolyte 80.

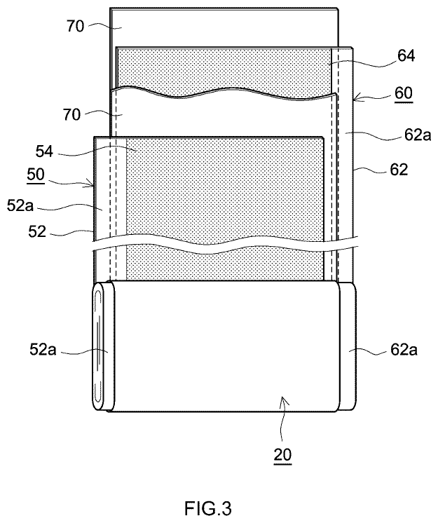

As illustrated in FIGS. 2 and 3, in the wound electrode body 20, a positive electrode sheet 50 and a negative electrode sheet 60 are stacked with two long separator sheets 70 interposed therebetween and are wound in the longitudinal direction.

As the positive electrode sheet 50, the positive electrode 50 according to this embodiment described above is used. In the positive electrode sheet 50, a positive electrode active material layer 54 is formed on one or each (each in this example) surface of a long positive electrode current collector 52 along the longitudinal direction. In the negative electrode sheet 60, a negative electrode active material layer 64 is formed on one or each (each in this example) surface of a long negative electrode current collector 62 along the longitudinal direction.

The positive electrode 50 includes the positive electrode active material layer non-formed portion 52a in which the positive electrode active material layer 54 is not formed and the positive electrode current collector 52 is exposed. The negative electrode 60 includes the negative electrode active material layer non-formed portion 62a in which the negative electrode active material layer 64 is not formed and the negative electrode current collector 62 is exposed. The positive electrode active material layer non-formed portion 52a and the negative electrode active material layer non-formed portion 62a extend off outward from both ends of the wound electrode body 20 in the winding axis direction (i.e., sheet width direction orthogonal to the longitudinal direction). The positive electrode current collector plate 42a and the negative electrode current collector plate 44a are respectively joined to the positive electrode active material layer non-formed portion 52a and the negative electrode active material layer non-formed portion 62a.

As the negative electrode current collector 62 constituting the negative electrode sheet 60, a known negative electrode current collector for use in a lithium ion secondary battery may be used, and examples of the negative electrode current collector include sheets or foil of highly conductive metals (e.g., copper, nickel, titanium, and stainless steel). The negative electrode current collector 62 is desirably copper foil.

Dimensions of the negative electrode current collector 62 are not particularly limited, and may be appropriately determined depending on battery design. In the case of using copper foil as the negative electrode current collector 62, the thickness thereof is not particularly limited, and is, for example, 5 μm or more and 35 μm or less, desirably 7 μm or more and 20 μm or less.

The negative electrode active material layer 64 contains a negative electrode active material. Examples of the negative electrode active material include: carbon materials such as graphite, hard carbon, and soft carbon; Si; and a composite material of Si and carbon. Graphite may be natural graphite or artificial graphite, and may be amorphous carbon-coated graphite in which graphite is coated with an amorphous carbon material.

The average particle size (D50) of the negative electrode active material is not specifically limited, and is, for example, 0.1 μm or more and 50 μm or less, desirably 1 μm or more and 25 μm or less, more desirably 5 μm or more and 20 μm or less.

The negative electrode active material layer 64 can include components other than the active material, such as a binder or a thickener. Examples of the binder include styrene-butadiene rubber (SBR) and polyvinylidene fluoride (PVDF). Examples of the thickener include carboxymethyl cellulose (CMC).

The content of the negative electrode active material in the negative electrode active material layer 64 is desirably 90% by mass or more, more desirably 95% by mass or more and 99% by mass or less. The content of the binder in the negative electrode active material layer 64 is desirably 0.1% by mass or more and 8% by mass or less, more desirably 0.5% by mass or more and 3% by mass or less. The content of the thickener in the negative electrode active material layer 64 is desirably 0.3% by mass or more and 3% by mass or less, more desirably 0.5% by mass or more and 2% by mass or less.

The thickness of the negative electrode active material layer 64 is not particularly limited, and is, for example, 10 μm or more and 300 μm or less, desirably 20 μm or more and 200 μm or less.

Examples of the separators 70 include a porous sheet (film) of a resin such as polyethylene (PE), polypropylene (PP), polyester, cellulose, and polyamide. The porous sheet may have a single-layer structure or a laminated structure of two or more layers (e.g., three-layer structure in which a PP layer is stacked on each surface of a PE layer). A heat-resistance layer (HRL) may be provided on a surface of each separator 70.

A nonaqueous electrolyte 80 typically includes a nonaqueous solvent and a supporting electrolyte (electrolyte salt). As the nonaqueous solvent, various organic solvents such as carbonates, ethers, esters, nitriles, sulfones, and lactones for use in an electrolyte of a typical lithium ion secondary battery can be used without any particular limitation. Specific examples of such a nonaqueous solvent include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), and trifluorodimethyl carbonate (TFDMC). Such nonaqueous solvents may be used alone or two or more of them may be used in combination.

Desired examples of the supporting electrolyte include lithium salts such as LiPF₆, LiBF₄, and lithium bis(fluorosulfonyl)imide (LiFSI) (desirably LiPF₆). The concentration of the supporting electrolyte is desirably 0.7 mol/L or more and 1.3 mol/L or less.

The nonaqueous electrolyte 80 may include components not described above, for example, various additives exemplified by: a film forming agent such as vinylene carbonate (VC) or an oxalato complex; a gas generating agent such as biphenyl (BP) or cyclohexylbenzene (CHB); and a thickener, to the extent that the effects of the present disclosure are not significantly impaired.

The thus-configured lithium ion secondary battery 100 has both an excellent capacity characteristic and an excellent output characteristic. That is, the lithium ion secondary battery 100 has large capacity and high output.

The lithium ion secondary battery 100 is applicable to various applications. Specific examples of application of the lithium ion secondary battery 100 include: portable power supplies for personal computers, portable electronic devices, portable terminals, and other devices; vehicle driving power supplies for vehicles such as electric vehicles (BEVs), hybrid electric vehicles (HEVs), and plug-in hybrid electric vehicles (PHEVs); and storage batteries for small power storage devices, and among these, vehicle driving power supplies are especially desirable. The lithium ion secondary battery 100 can be used in a form of a battery module in which a plurality of batteries are typically connected in series and/or in parallel.

The foregoing description is directed to the square lithium ion secondary battery 100 including the flat wound electrode body 20 as an example. Alternatively, the lithium ion secondary battery disclosed here can also be configured as a lithium ion secondary battery including a stacked-type electrode body (i.e., electrode body in which a plurality of positive electrodes and a plurality of negative electrodes are alternately stacked). The nonaqueous electrolyte secondary battery disclosed here may also be configured as a cylindrical lithium ion secondary battery, a laminated case type lithium ion secondary battery, or a coin type lithium ion secondary battery, for example.

By using the positive electrode described above, a secondary battery other than a lithium ion secondary battery can be constituted according to a known method. On the other hand, an all-solid-state secondary battery (especially all-solid-state lithium ion secondary battery) can be constituted according to a known method by using a solid electrolyte instead of the nonaqueous electrolyte 80.

Examples of the present disclosure will now be described, but are not intended to limit the present disclosure to these examples.

### Examples 1 to 14 and Comparative Examples 1 to 5

As a precursor of a positive electrode active material, a nickel cobalt manganese composite hydride expressed by Ni_{1/3}Co_{1/3}Mn_{1/3}(OH)₂ was prepared.

A first lithium composite oxide was produced in the following manner. First, a prepared composite hydride and a lithium source (lithium carbonate) were mixed in a Li/Me ratio shown in Tables 1 and 2. The resulting mixture was fired at temperatures shown in Tables 1 and 2 for 12 hours, thereby obtaining a first lithium composite oxide (lithium nickel cobalt manganese composite oxide). It should be noted that in Examples 7, 13, and 14, a composite hydride having an average particle size (D50) of 7 μm was used, in Examples 9 and 10, a composite hydride having an average particle size (D50) of 3 μm was used, in Example 11, a composite hydride having an average particle size (D50) of 2 μm was used, in Example 12, a composite hydride having an average particle size (D50) of 11 μm was used, and in the other examples and comparative examples, a composite hydride having an average particle size (D50) of 9 μm was used. Tables 1 and 2 show values of the average particle size (D50) of the first lithium composite oxide measured with a commercially available laser diffraction scattering particle size distribution analyzer.

A second lithium composite oxide was produced in the following manner. First, the composite hydride described above and a lithium source (lithium carbonate) were mixed in a Li/Me ratio shown in Tables 1 and 2. The resulting mixture was fired at temperatures shown in Tables 1 and 2 for 12 hours, thereby obtaining a second lithium composite oxide (lithium nickel cobalt manganese composite oxide). In Example 8, a composite hydride having an average particle size (D50) of 7 μm was used, in Example 13, a composite hydride having an average particle size (D50) of 3 μm was used, in Example 14, a composite hydride having an average particle size (D50) of 11 μm was used, and in the other examples and comparative examples, a composite hydride having an average particle size (D50) of 9 μm was used. Tables 1 and 2 show values of the average particle size (D50) of the second lithium composite oxide measured with a commercially available laser diffraction scattering particle size distribution analyzer.

The thus-obtained first and second lithium composite oxides were mixed in mass ratios shown in Tables 1 and 2, thereby obtaining a positive electrode active material.

The obtained positive electrode active material, acetylene black (AB) as a conductive material, and polyvinylidene fluoride (PVDF) as a binder were mixed at a mass ratio of positive electrode active material:AB:PVDF=85:10:5 in N-methylpyrrolidone (NMP), thereby preparing a paste for forming a positive electrode active material layer. This paste was applied onto aluminium foil with a thickness of 15 μm and dried, thereby producing a positive electrode sheet.

Natural graphite (C) as a negative electrode active material, styrene-butadiene rubber (SBR) as a binder, and carboxymethyl cellulose (CMC) as a thickener were mixed at a mass ratio of C:SBR:CMC=98:1:1 in ion-exchanged water, thereby preparing a paste for forming a negative electrode active material layer. This paste was applied onto copper foil with a thickness of 10 μm and dried, thereby producing a negative electrode sheet.

As a separator sheet, a porous polyolefin sheet having a thickness of 20 μm and a three-layer structure of PP/PE/PP was prepared.

The positive electrode sheet, the negative electrode sheet, and the separator sheet were stacked, and an electrode terminal was attached to the stack of the positive electrode sheet, the negative electrode sheet, and the separator sheets, and these members were housed in a laminated case. Subsequently, a nonaqueous electrolyte was poured in the laminated case, and the laminated case was hermetically sealed. As the nonaqueous electrolyte, a nonaqueous electrolyte in which LiPF₆ as a supporting electrolyte was dissolved at a concentration of 1.0 mol/L in a mixed solvent including ethylene carbonate (EC), dimethyl carbonate (DMC), and ethyl methyl carbonate (EMC) at a volume ratio of 3:4:3 was used. In this manner, evaluation lithium ion secondary batteries according to the examples and the comparative examples were obtained.

### <Measurement of Crystallite Size>

Each of the thus-obtained first and second lithium composite oxides was analyzed with an XRD device “smart Lab” (manufactured by Rigaku) and analysis software “PDXL2” (manufactured by Rigaku), and a crystallite size was determined by using a full width at half maximum of a diffraction peak (2θ=44±1°) belonging to a (004) plane, a 2θ value, and a Scherrer equation. Tables 1 and 2 show results.

### <Activation and Initial Capacitance Measurement>

Each evaluation lithium ion secondary battery fabricated as described above was placed in an environment at 25° C. In activation (initial charge), a constant current-constant voltage technique was employed, each evaluation lithium ion secondary battery was subjected to a constant-current charge to 4.2 V at a current value of ⅓C, and then, subjected to constant-current charge to a current value of 1/50C so as to be fully charged. Thereafter, the evaluation lithium ion secondary battery was discharged with a constant current to 3.0 V at a current value of ⅓C. A discharge capacity at this time was measured to obtain an initial capacity. Supposing an initial capacity of Comparative Example I was one, initial capacity ratios of the other comparative examples and examples were obtained. Tables 1 and 2 show results.

### <Output Characteristic Evaluation>

Each evaluation lithium ion secondary battery was subjected to the activation treatment, adjusted to have an SOC of 60%, and placed in an environment of −10° C. The evaluation lithium ion secondary battery was discharged at a current value of 15C for two seconds. Based on the voltage and the current value at this time, an output (W) was calculated. Supposing an output of the evaluation lithium ion secondary battery using the positive electrode active material obtained in Comparative Example I was one, ratios of outputs of the evaluation lithium ion secondary batteries using the positive electrode active materials obtained in the other comparative examples and examples were obtained. Tables 1 and 2 show results.

TABLE 1

| | | | | | | | | | | Battery | |
|---|---|---|---|---|---|---|---|---|---|---|---|
| | First lithium composite oxide | | | | Second lithium composite oxide | | | | | performance | |
| | | Firing | Crystallite | | | Firing | Crystallite | | | Initial | |
| | Li/Me | temperature | size | D50 | Li/Me | temperature | size | D50 | Mixing ratio | capacity | Output |
| | ratio | (° C.) | (Å) | (μm) | ratio | (° C.) | (Å) | (μm) | first:second | ratio | ratio |
| Comparative | 1.00 | 890 | 1000 | 10 | 1.10 | 880 | 1000 | 10 | 50:50 | 1 | 1 |
| Example 1 | | | | | | | | | | | |
| Comparative | 0.85 | 930 | 1000 | 10 | 1.10 | 880 | 1000 | 10 | 50:50 | 1 | 1 |
| Example 2 | | | | | | | | | | | |
| Comparative | 0.97 | 900 | 1000 | 10 | 1.25 | 850 | 1000 | 10 | 50:50 | 0.97 | 1 |
| Example 3 | | | | | | | | | | | |
| Comparative | 0.97 | 900 | 1000 | 10 | 1.09 | 890 | 1000 | 10 | 50:50 | 0.98 | 1 |
| Example 4 | | | | | | | | | | | |
| Comparative | 0.97 | 900 | 1000 | 10 | not used | | | | 100:0 | 1 | 1 |
| Example 5 | | | | | | | | | | | |
| Comparative | not used | | | | 1.10 | 880 | 1000 | 10 | 0:100 | 1 | 1.05 |
| Example 6 | | | | | | | | | | | |
| Comparative | 0.97 | 900 | 1000 | 10 | 1.10 | 880 | 1000 | 10 | 50:50 | 1.05 | 1 |
| Example 7 | | | | | | | | | | | |
| Comparative | 0.95 | 910 | 1000 | 10 | 1.10 | 880 | 1000 | 10 | 50:50 | 1.05 | 1 |
| Example 8 | | | | | | | | | | | |
| Comparative | 0.90 | 920 | 1000 | 10 | 1.10 | 880 | 1000 | 10 | 50:50 | 1.05 | 1 |
| Example 9 | | | | | | | | | | | |
| Comparative | 0.97 | 900 | 1000 | 10 | 1.15 | 870 | 1000 | 10 | 50:50 | 1.04 | 1 |
| Example 10 | | | | | | | | | | | |
| Comparative | 0.97 | 900 | 1000 | 10 | 1.20 | 860 | 1000 | 10 | 50:50 | 1.03 | 1 |
| Example 11 | | | | | | | | | | | |
| Comparative | 0.97 | 900 | 1000 | 10 | 1.10 | 880 | 1000 | 10 | 30:70 | 1.045 | 1 |
| Example 12 | | | | | | | | | | | |
| Comparative | 0.97 | 900 | 1000 | 10 | 1.10 | 880 | 1000 | 10 | 10:90 | 1.04 | 1 |
| Example 13 | | | | | | | | | | | |
| Comparative | 0.97 | 900 | 1000 | 10 | 1.10 | 880 | 1000 | 10 | 5:95 | 1.03 | 1 |
| Example 14 | | | | | | | | | | | |
| Comparative | 0.97 | 900 | 1000 | 10 | 1.10 | 850 | 800 | 10 | 50:50 | 1.05 | 1 |
| Example 15 | | | | | | | | | | | |

TABLE 2

| | | | | | | | | | | Battery | |
|---|---|---|---|---|---|---|---|---|---|---|---|
| | First lithium composite oxide | | | | Second lithium composite oxide | | | | | performance | |
| | | Firing | Crystallite | | | Firing | Crystallite | | | Initial | |
| | Li/Me | temperature | size | D50 | Li/Me | temperature | size | D50 | Mixing ratio | capacity | Output |
| | ratio | (° C.) | (Å) | (μm) | ratio | (° C.) | (Å) | (μm) | first:second | ratio | ratio |
| Comparative | 1.00 | 800 | 600 | 10 | 1.10 | 850 | 800 | 10 | 50:50 | 1 | 1.1 |
| Example 16 | | | | | | | | | | | |
| Comparative | 0.85 | 850 | 600 | 10 | 1.10 | 850 | 800 | 10 | 50:50 | 1 | 1.1 |
| Example 17 | | | | | | | | | | | |
| Comparative | 0.97 | 810 | 600 | 10 | 1.25 | 800 | 800 | 10 | 50:50 | 0.97 | 1.1 |
| Example 18 | | | | | | | | | | | |
| Comparative | 0.97 | 810 | 600 | 10 | 1.09 | 860 | 800 | 10 | 50:50 | 0.98 | 1.1 |
| Example 19 | | | | | | | | | | | |
| Comparative | 0.97 | 750 | 300 | 10 | 1.10 | 850 | 800 | 10 | 50:50 | 1.05 | 1 |
| Example 20 | | | | | | | | | | | |
| Comparative | 0.97 | 810 | 600 | 10 | 1.10 | 800 | 500 | 10 | 50:50 | 1.05 | 1 |
| Example 21 | | | | | | | | | | | |
| Example 1 | 0.97 | 810 | 600 | 10 | 1.15 | 840 | 800 | 10 | 50:50 | 1.04 | 1.1 |
| Example 2 | 0.97 | 810 | 600 | 10 | 1.20 | 830 | 800 | 10 | 50:50 | 1.03 | 1.1 |
| Example 3 | 0.97 | 810 | 600 | 10 | 1.10 | 850 | 800 | 10 | 50:50 | 1.05 | 1.1 |
| Example 4 | 0.95 | 820 | 600 | 10 | 1.10 | 850 | 800 | 10 | 50:50 | 1.05 | 1.1 |
| Example 5 | 0.90 | 830 | 600 | 10 | 1.10 | 850 | 800 | 10 | 50:50 | 1.05 | 1.1 |
| Example 6 | 0.97 | 780 | 400 | 10 | 1.10 | 850 | 800 | 10 | 50:50 | 1.05 | 1.2 |
| Example 7 | 0.97 | 780 | 400 | 8 | 1.10 | 850 | 800 | 10 | 50:50 | 1.05 | 1.3 |
| Example 8 | 0.97 | 780 | 400 | 10 | 1.10 | 850 | 800 | 8 | 50:50 | 1.05 | 1.2 |
| Example 9 | 0.97 | 780 | 400 | 3 | 1.10 | 850 | 800 | 10 | 50:50 | 1.05 | 1.3 |
| Example 10 | 0.97 | 780 | 400 | 3 | 1.10 | 810 | 600 | 10 | 50:50 | 1.05 | 1.35 |
| Example 11 | 0.97 | 780 | 400 | 2 | 1.10 | 850 | 800 | 10 | 50:50 | 1.05 | 1.2 |
| Example 12 | 0.97 | 780 | 400 | 12 | 1.10 | 850 | 800 | 10 | 50:50 | 1.05 | 1.2 |
| Example 13 | 0.97 | 780 | 400 | 8 | 1.10 | 850 | 800 | 3 | 50:50 | 1.05 | 1.2 |
| Example 14 | 0.97 | 780 | 400 | 8 | 1.10 | 850 | 800 | 12 | 50:50 | 1.05 | 1.2 |

The results of Tables 1 and 2 show that capacity and output are both high in a case where the Li/Me ratio in the first lithium composite oxide is 0.90 to 0.97, the Li/Me ratio in the second lithium composite oxide is 1.10 to 1.20, the crystallite size of the (104) plane of the first lithium composite oxide is 400 Å to 600 Å, and the crystallite size of the (104) plane of the second lithium composite oxide is larger than the crystallite size of the (104) plane of the first lithium composite oxide.

Thus, the positive electrode disclosed here can provide the secondary battery with both a capacity characteristic and an output characteristic at high level.

Specific examples of the present disclosure have been described in detail hereinbefore, but are merely illustrative examples, and are not intended to limit the scope of claims. The techniques described in claims include various modifications and changes of the above exemplified specific examples.

That is, the positive electrode and the secondary battery disclosed here are items [1] to [6].

[1] A positive electrode including: a positive electrode current collector; and a positive electrode active material layer supported by the positive electrode current collector, in which

the positive electrode active material layer includes a first lithium composite oxide having a layered structure and a second lithium composite oxide having a layered structure,

in the first lithium composite oxide, a mole ratio of Li to a metal other than Li is 0.90 to 0.97,

in the second lithium composite oxide, a mole ratio of Li to a metal other than Li is 1.10 to 1.20,

a crystallite size of a (104) plane of the first lithium composite oxide is 400 Å to 600 Å, and

a crystallite size of a (104) plane of the second lithium composite oxide is larger than the crystallite size of the (104) plane of the first lithium composite oxide.

[2] The positive electrode of item [1], in which

the crystallite size of the (104) plane of the second lithium composite oxide is larger than the crystallite size of the (104) plane of the first lithium composite oxide by 100 Å or more, and

the crystallite size of the (104) plane of the second lithium composite oxide is 600 Å to 800 Å.

[3] The positive electrode of item [1] or [2], in which both the first lithium composite oxide and the second lithium composite oxide are lithium nickel cobalt manganese composite oxides.
[4] The positive electrode of any one of items [1] to [3], in which the first lithium composite oxide is an oxide collected by a used lithium ion secondary battery.
[5] The positive electrode of any one of items [1] to [4], in which an average particle size (D50) of the first lithium composite oxide is 3 μm to 8 μm.
[6] A secondary battery including:

the positive electrode of any one of items [1] to [5];

a negative electrode; and

an electrolyte.

What is claimed is:

1. A positive electrode comprising:
a positive electrode current collector; and
a positive electrode active material layer supported by the positive electrode current collector, wherein
the positive electrode active material layer includes a first lithium composite oxide having a layered structure and a second lithium composite oxide having a layered structure,
in the first lithium composite oxide, a mole ratio of Li to a metal other than Li is 0.90 to 0.97,
in the second lithium composite oxide, a mole ratio of Li to a metal other than Li is 1.10 to 1.20,
a crystallite size of a (104) plane of the first lithium composite oxide is 400 Å to 600 Å, and
a crystallite size of a (104) plane of the second lithium composite oxide is larger than the crystallite size of the (104) plane of the first lithium composite oxide.

2. The positive electrode according to claim 1, wherein
the crystallite size of the (104) plane of the second lithium composite oxide is larger than the crystallite size of the (104) plane of the first lithium composite oxide by 100 Å or more, and
the crystallite size of the (104) plane of the second lithium composite oxide is 600 Å to 800 Å.

3. The positive electrode according to claim 1, wherein both the first lithium composite oxide and the second lithium composite oxide are lithium nickel cobalt manganese composite oxides.

4. The positive electrode according to claim 1, wherein the first lithium composite oxide is an oxide collected by a used lithium ion secondary battery.

5. The positive electrode according to claim 1, wherein an average particle size (D50) of the first lithium composite oxide is 3 μm to 8 μm.

6. A secondary battery comprising:
the positive electrode according to claim 1;
a negative electrode; and
an electrolyte.
